(19) United States
(12) Patent Application Publication
(10) Pub. No.: US 2024/0346199 A1
(43) Pub. Date: Oct. 17, 2024

(54) A FLOW-BASED METHOD FOR STRIKE SURVIVAL MODELING

(71) Applicant: Natel Energy Holdings, Inc., Alameda, CA (US)

(72) Inventors: Abraham D. SCHNEIDER, San Franciso, CA (US); Sterling Marina WATSON, San Francisco, CA (US)

(21) Appl. No.: 18/294,991

(22) PCT Filed: Aug. 3, 2022
(86) PCT No.: PCT/US2022/039331

§ 371 Date: Feb. 2, 2024

Related U.S. Application Data
(60) Provisional application No. 63/228,912, filed on Aug. 3, 2021.

(51) Int. Cl. G06F 30/17

(52) U.S. Cl. CPC G06F 30/17

(57) ABSTRACT

Computational fluid dynamics (CFD) models offer a useful approach for assessing the biological performance of a turbine if the mechanisms of injury are modeled accurately. and could be used as a design tool in the development of fish-safe designs. A novel strike intensity metric (HIT metric) derived from spherical discrete element model (DEM) particle trajectory data is correlated to observed survival outcomes in the laboratory for rainbow trout struck by a variety of blade geometries. and the model enables improved survival predictions. The modeling method also allows survival prediction for strikes with arbitrary geometries and is extensible to apply to a wide range of organisms. The CFD simulated organism can comprise a single DEM particle or a cluster of DEM particles. The simulation of organism-flowfield interaction can include both passive advection and contact dynamics.

### CROSS-REFERENCE TO RELATED APPLICATIONS

This application claims benefit of U.S. Provisional Patent Application No. 63/228,912, filed Aug. 3, 2021, which is incorporated herein in its entirety by reference thereto.

### FIELD

Aspects of present disclosure generally relate to a method of estimating the survival rate of organisms, such as fish, after an impact with an object, such as a hydropower turbine blade. More specifically, aspects of present disclosure relate to a method of estimating fish survival rate using computational fluid dynamics simulation.

### BACKGROUND

Hydropower facilities pose a threat to passage of fish and other aquatic organisms, and modern hydropower facilities often can only be implemented if the hydropower scheme can pass rigorous criteria for environmental sustainability. However, it can be difficult to evaluate the effect of the passage through a turbine on fish and other aquatic organisms prior to installation, and if it is determined that a turbine poses significant risk to fish and other aquatic organisms, re-design and re-installation could incur significant cost.

### BRIEF SUMMARY

Some aspects of the disclosure relate to a method of modeling strike survival rate of an organism. The method can include striking an organism with an object under different strike conditions, recording a survival rate of the organism under each of the strike conditions, performing a regression analysis on the recorded strike survival rates to result in a relationship between strike survival rate and strike intensity metric, simulating the organism, the object, and the strike conditions in a computational fluid dynamic model, calculating a strike intensity metric experienced by the simulated organism under each of the simulated strike conditions, and estimating strike survival rates of the simulated organism under the simulated strike conditions based on the relationship between strike survival rate and strike intensity metric.

In some aspects, the strike conditions can include a strike velocity, a geometry of the object, and a geometry of the organism.

In some aspects, the organism can be fish, and the geometry of the organism can include a length of the fish.

In some aspects, the length of fish can be in a range of 60 mm to 600 mm.

In some aspects, the object can be a hydropower turbine blade, and the geometry of the object can include a thickness of the blade and a leading edge slant angle of the blade.

In some aspects, the leading edge slant angle can be in a range of 30 degrees to 90 degrees.

In some aspects, the thickness of the blade can be in a range of 10 mm to 250 mm.

In some aspects, the strike velocity can be in a range of 3.0 m/s to 25 m/s.

In some aspects, the calculating strike intensity metric can include determining the moment of strike, where the simulated organism contacts the simulated object, determining components of a pre-strike velocity of the simulated organism at a first distance before the moment of strike, determining components of a post-strike velocity of the simulated organism at a second distance after the moment of strike, and calculating the strike intensity metric as the magnitude of components of a change in the pre-strike velocity and the post-strike velocity.

In some aspects, the first distance and the second distance can be equal.

In some aspects, the organism can be a rainbow trout having a length, and the first distance and the second distance can be both in a range of 0.04 times to 0.06 times of the length of the rainbow trout.

In some aspects, the step of simulating can include simulating the organism as spherical discrete element method (DEM) particles.

In some aspects, the step of simulating can include simulating the organism as non-spherical discrete element method (DEM) particles.

In some aspects, the step of simulating can include simulating the organism as clusters of discrete element method (DEM) particles.

In some aspects, the regression analysis can be a log-logistic regression analysis.

### BRIEF DESCRIPTION OF THE DRAWINGS

The accompanying drawings, which are incorporated herein and form a part of the specification, illustrate the present disclosure and, together with the description, further serve to explain the principles thereof and to enable a person skilled in the pertinent art to make and use the same.

FIG. 1 is a blade setup in a live fish strike testing according to some aspects.

FIG. 2 shows the blade geometries tested in strike testing according to some aspects.

FIG. 3 is a computational fluid dynamics model of strike testing according to some aspects.

FIG. 4 shows a trajectory comparison of streamlines, Lagrangian particles, and DEM particles released from three different locations ahead of a RHT100 blade.

FIG. 5A shows components and magnitude of velocity near strike plotted against path length for streamline simulation according to some aspects.

FIG. 5B shows components and magnitude of velocity near strike plotted against path length for Lagrangian particles simulation according to some aspects.

FIG. 5C shows components and magnitude of velocity near strike plotted against path length for DEM particles simulation according to some aspects.

FIG. 6 shows the percent error of parameters b and e in a 2-parameter log-logistic curve for variable pre-and post-strike sampling length.

FIG. 7A shows strike survival plotted against strike velocity magnitude calculated by streamline simulation according to some aspects.

FIG. 7B shows strike survival plotted against strike velocity magnitude calculated by Lagrangian particles simulation according to some aspects.

FIG. 8 shows strike survival plotted against DEM particles HIT metric representing the change in components of velocity, along with the log-logistic regression, according to some aspects.

FIG. 9 is a method of estimating survival rate of an organism striking a surface of an object according to some aspects.

FIG. 10 is a computational fluid dynamics model of a hydropower turbine according to some aspects.

FIG. 11 shows a subset of simulated fish trajectories upon interaction with the turbine of FIG. 10.

FIG. 12 shows the population survival rate estimate for the turbine of FIG. 10.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one aspect,” “an aspect,” “an example aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Downstream passage of fish and other aquatic organisms through hydropower facilities poses a threat to many riverine fish species, and significant population-level risks for migratory species encountering multiple hydropower facilities in their migration to the ocean. It is therefore desirable for hydropower facilities to have a minimal effect on fish and other aquatic organisms (e.g., by not harming the organisms). Due to the significant installation, operation, and maintenance costs of hydropower facilities, as well as regulatory requirements applicable to new hydropower facilities, it may also be desirable or necessary to understand the effect that downstream passage through a hydropower turbine will have on fish and other aquatic organisms prior to installation.

Development of accurate survival modeling tools is useful for assessing the likelihood of fish injury and mortality in response to the primary threats that fish face in hydropower turbines: rapid decompression, shear injury, and blade strike. These survival modeling tools can also be used in the turbine design process to develop safer blade geometries and operating modes that improve survival outcomes for downstream passing fish.

In current disclosure, three different blade strike modeling approaches based on CFD simulation of controlled blade strikes performed in the laboratory are compared: massless streamlines, spherical Lagrangian particles, and spherical discrete element method (“DEM”) particles, and a strike intensity metric (“HIT metric”) based on a correlation of particle trajectory data to strike survival data is proposed. It is concluded that a HIT metric derived from DEM particles has a most robust correlation to strike survival rate.

While the modeling method of current disclosure is tested with an analogue turbine blade striking with fish of a particular species, it is understood that the method is not limited to turbine blade or fish. In some aspects, the modeling method is also applicable to other fish species or aquatic organisms, such as aquatic frogs, crayfish, or eggs. In some aspects, the modeling method can be applied to model the strike effect of any object with an arbitrary geometry, such as stayvanes, wicket gates, piers, or any arbitrary surface. Finally, while only three CFD simulation approaches are tested, any other commonly known CFD simulation approach, such as clusters of particles, can also be applied in the modeling method of current disclosure.

### Methods

In current disclosure, fish survival data from 45 blade strike conditions were used to relate experimental blade strike data of live fish to estimate survival rates for strikes simulated in CFD.

### Live Fish Laboratory Strike Testing

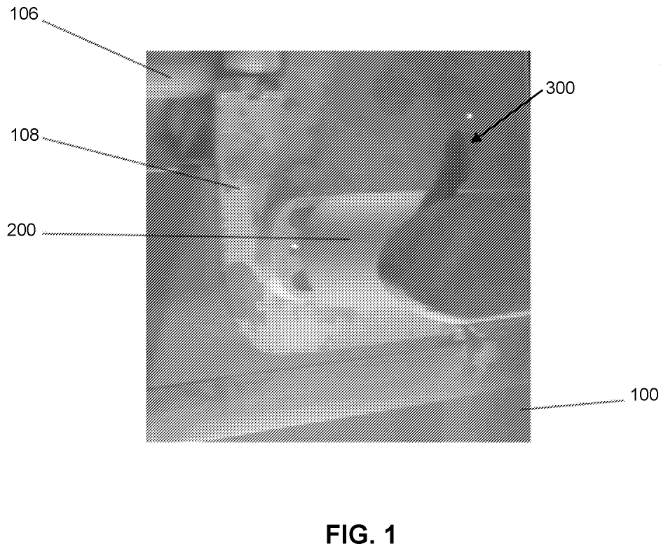

The live fish strike survival data used in current disclosure comes from two separate studies performed with rainbow trout (Oncorhynchus mykiss) in a linear fish strike facility: the first study conducted in 2006 and 2007, and the second study conducted in 2019. As shown in FIG. 1, the linear strike facility consisted of a flume 100 of rectangular cross section, equipped with a set of guide rails 106 onto which a movable cart 108 was mounted; blades 200 of different geometry were interchangeably mounted to the cart 108. Cart 108 was pulled at a specified velocity, for example in a range of 3.0 m/s to 12 m/s, by a winch and cable, striking an anaesthetized fish 300 (i.e. rainbow trout) positioned in a repeatable location and oriented at a 90° angle to oncoming blade 200. In these studies, the parameters affecting fish strike survival include blade velocity (i.e. strike velocity), L/t ratio (where/, is the length of fish 300 and/is the thickness of the blade leading edge), and leading edge slant angle was evaluated.

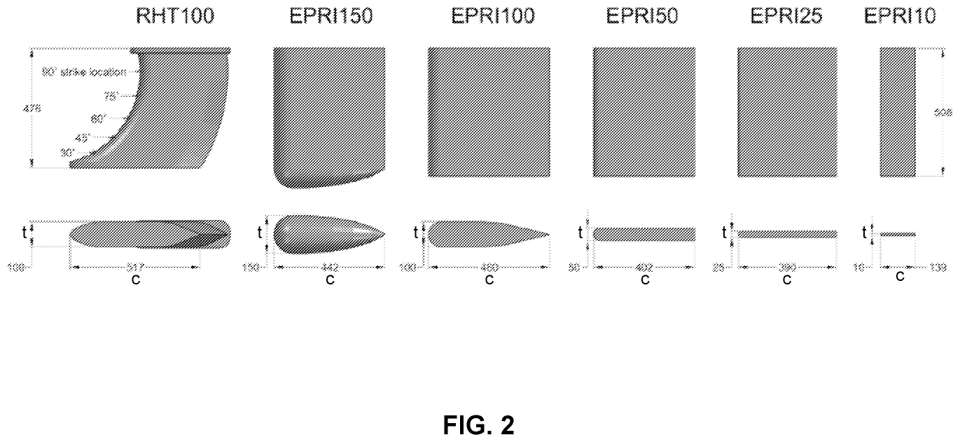

FIG. 2 shows in total six different geometries for blade 200 that were tested. In the first study conducted in 2006 and 2007, blades with straight leading edges having thickness t of 10, 25, 50, 100, and 150 mm (EPRI150, EPRI100, EPRI50, EPRI 25, EPRI10) were tested, having chord lengths c of 139, 390, 402, 480, and 442 mm respectively, at blade speeds in a range of 3.0 m/s to 12.1 m/s, with fish lengths L in a range of 108 to 264 mm (corresponding to L/t ratios of 0.67 to 25). Table 1 records the strike conditions A-X tested in the first study conducted in 2006 and 2007, together with total number of fish tested N, offset of the center of mass of the fish relative to blade centerline, and the average survival rate for each condition.

In the second study conducted in 2019, a new blade geometry (RHT100) was tested, having a thickness tof 100 mm, a chord length c of approximately 517, and a curved leading edge, allowing strikes to be performed at slant angles at a range of 30° to 90°. In the second study conducted in 2019, two fish size groups were tested corresponding to L/t ratios in a range of approximately 1.4 to approximately 2, blade velocity 7.0 m/s to 12.0 m/s, at five locations along the curved leading edge of the RHT100 blade corresponding to slant angles in a range of 90° to 30°. Table 2 records the strike conditions a-u tested in the second study conducted in 2019, together with total number of fish tested N, offset of the center of mass of the fish relative to blade centerline, and the average survival rate for each condition.

High speed video was captured for all strikes and was analyzed to determine the position of the fish relative to the blade centerline prior to strike.

TABLE 1
Strike conditions from the first study conducted in 2006 and 2007.

| | | Slant | Cart | Fish | | Ctr | Strike |
|---|---|---|---|---|---|---|---|
| | | angle | speed | length | | offset | surv |
| | Blade | (°) | (m/s) | (mm) | N | (mm) | (%) |
| A | EPRI50 | 90 | 3.1 | 193 | 49 | 7.9 | 91.8 |
| B | EPRI50 | 90 | 5.0 | 201 | 48 | 13.1 | 93.8 |
| C | EPRI50 | 90 | 7.3 | 190 | 32 | 14.1 | 59.4 |
| D | EPRI25 | 90 | 3.0 | 241 | 50 | 13.7 | 100.0 |
| E | EPRI25 | 90 | 4.9 | 241 | 50 | 16.6 | 94.0 |
| F | EPRI25 | 90 | 7.0 | 240 | 47 | −2.9 | 38.3 |
| G | EPRI10 | 90 | 3.1 | 240 | 50 | 24.5 | 100.0 |
| H | EPRI10 | 90 | 5.0 | 239 | 49 | 15.3 | 98.0 |
| I | EPRI10 | 90 | 7.2 | 264 | 44 | 2.6 | 20.5 |
| J | EPRI150 | 90 | 7.3 | 156 | 49 | 18.7 | 98.0 |
| K | EPRI50 | 90 | 7.2 | 111 | 48 | −3.0 | 79.2 |
| L | EPRI50 | 90 | 8.2 | 115 | 49 | −13.7 | 32.7 |
| M | EPRI100 | 90 | 7.4 | 111 | 50 | −1.8 | 100.0 |
| N | EPRI100 | 90 | 8.1 | 119 | 14 | −23.0 | 92.9 |
| O | EPRI100 | 90 | 8.6 | 109 | 47 | −4.5 | 91.5 |
| P | EPRI100 | 90 | 8.6 | 174 | 49 | −7.3 | 55.1 |
| Q | EPRI100 | 90 | 10.6 | 112 | 49 | −6.8 | 36.7 |
| R | EPRI100 | 90 | 8.5 | 114 | 24 | −2.7 | 83.3 |
| S | EPRI150 | 90 | 8.6 | 140 | 24 | −6.7 | 95.8 |
| T | EPRI100 | 90 | 10.7 | 108 | 49 | −6.7 | 53.1 |
| U | EPRI100 | 90 | 8.5 | 108 | 50 | −8.3 | 94.0 |
| V | EPRI150 | 90 | 10.7 | 110 | 50 | −2.5 | 94.0 |
| W | EPRI150 | 90 | 12.0 | 113 | 50 | −6.7 | 98.0 |
| X | EPRI150 | 90 | 12.1 | 147 | 50 | −20.0 | 86.0 |

TABLE 2
Strike conditions from the second study conducted in 2019.

| | | Slant | Cart | Fish | | Ctr | Strike |
|---|---|---|---|---|---|---|---|
| | | angle | speed | length | | offset | surv |
| | Blade | (°) | (m/s) | (mm) | N | (mm) | (%) |
| a | EPRI100 | 90 | 10.0 | 137 | 50 | 28.8 | 100.0 |
| b | EPRI100 | 90 | 10.0 | 196 | 50 | 35.3 | 68.0 |
| c | EPRI100 | 90 | 10.3 | 195 | 38 | −7.8 | 7.9 |
| d | RHT100 | 30 | 7.0 | 141 | 100 | 19.7 | 100.0 |
| e | RHT100 | 30 | 7.1 | 207 | 100 | 10.4 | 100.0 |
| f | RHT100 | 30 | 9.9 | 143 | 101 | 5.7 | 99.0 |
| g | RHT100 | 30 | 10.0 | 203 | 100 | 6.1 | 98.0 |
| h | RHT100 | 30 | 12.0 | 143 | 25 | 4.3 | 88.0 |
| i | RHT100 | 30 | 12.0 | 136 | 101 | 1.4 | 83.2 |
| j | RHT100 | 30 | 12.0 | 199 | 101 | −2.0 | 71.3 |
| k | RHT100 | 45 | 9.9 | 197 | 50 | 13.8 | 96.0 |
| l | RHT100 | 45 | 11.6 | 143 | 25 | 2.9 | 56.0 |
| m | RHT100 | 60 | 7.1 | 141 | 100 | 11.3 | 99.0 |
| n | RHT100 | 60 | 7.1 | 207 | 100 | 16.6 | 99.0 |
| o | RHT100 | 60 | 9.9 | 136 | 101 | 8.2 | 85.1 |
| p | RHT100 | 60 | 10.0 | 199 | 100 | 13.9 | 65.0 |
| q | RHT100 | 60 | 12.0 | 137 | 51 | 1.4 | 13.7 |
| r | RHT100 | 60 | 11.7 | 172 | 25 | −13.8 | 4.2 |
| s | RHT100 | 75 | 9.9 | 201 | 20 | 32.2 | 60.0 |
| t | RHT100 | 90 | 7.0 | 199 | 50 | 25.9 | 100.0 |
| u | RHT100 | 90 | 9.9 | 197 | 41 | −7.9 | 26.8 |

### CFD Simulation of Strike Test Flume

Each physical strike test condition (i.e. strike conditions A-X and a-u) was simulated in a 3D computational fluid dynamic model of the linear strike flume.

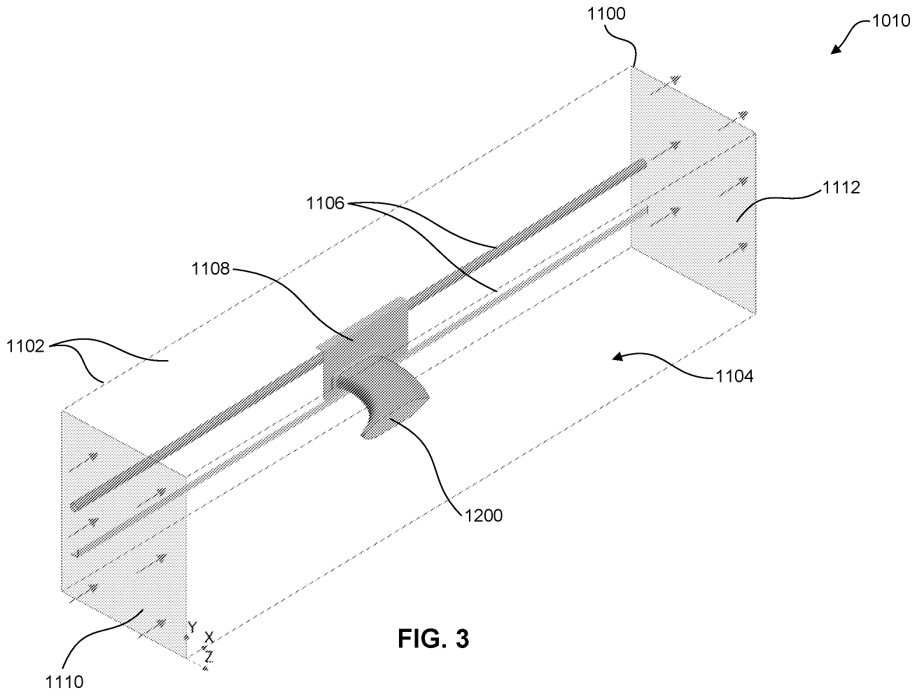

FIG. 3 illustrates the geometry used to construct the CFD model. A single fluid region 1010 of rectangular prismatic shape replicates the form of linear strike flume facility 10. The strike blade assembly, consisting of blade 1200 mounted to a simplified version of the cart 1108, is centered lengthwise in the flume 1100, with approximately 5 chord lengths of flume upstream and down-stream of blade 200. Blade 1200 can have any geometry shown in FIG. 2, for example, RHT100 is used in the aspect as shown in FIG. 3. Cart guide rails 1106 are modeled as extending through the entire domain. Fluid region 1010 and walls of cart 1108 including blade 1200 were modeled as stationary, with a uniform velocity boundary condition applied to an inlet 1110 and a uniform pressure outlet boundary condition applied to an outlet 1112. Fluid volume of flume 1100 was modeled as wall-bounded (with no-slip condition) on all four sides, and walls 1102 were modeled as moving with the same velocity as was applied to inlet 1110.

The 3D segregated RANS solver with second-order convection scheme was used in conjunction with the SST (Menter) k-w turbulence model and an all-y⁺ wall treatment.

Some of the blades 1200 have geometry which is susceptible to flow separation, such as rapidly tapering or blunt trailing edges. For this reason, a low-y⁺ mesh was utilized.

Strikes were simulated at velocities in a range of 3 m/s to 12.1 m/s. At the maximum speed, y⁺ was 3 on 99.96% of all wall-adjacent prism cells.

### Fish Strike Modeling Approaches

Massless streamlines, Lagrangian particles, and DEM particles were used to simulate the interaction of fish with the blade leading edge in a CFD model. The particles were injected approximately 1.5 m upstream of the blade with a y-offset corresponding to the location of the fish center of mass for each test condition.

The streamline representation simply treated the fish as a passively advected particle moving through the flow domain at the velocity of the surrounding flow. In contrast, both the Lagrangian and DEM approaches represented the fish as a spherical particle which was acted upon by the flow. The Lagrangian/DEM particle velocity \vec{uₚ} was determined by solving the conservation equation of motion in the Lagrangian framework (Equation 1), in which the particle was acted upon by drag \vec{F_{d}}, pressure gradient force \vec{Fₚ}, virtual mass force \vec{F_{νm}}, gravity force \vec{F_{g}}, and in the DEM case, a contact force \vec{F_{c}}. The Lagrangian sphere contact was detected by the intersection of the sphere centroid with a wall, while the DEM approach resolved contact of the spherical particle surface with the wall and computed contact force from particle-wall overlap, making it more physically realistic.

$${m}_{p} \frac{\vec{{du}_{p}}}{dt} = \vec{{F}_{d}} + \vec{{F}_{p}} + \vec{{F}_{vm}} + \vec{{F}_{g}} + \vec{{F}_{c}} \qquad ( 1 )$$

The particle diameter for both Lagrangian and DEM approaches was chosen based on the diameter of an equivalent mass sphere for each fish size, and particle density was set equal to the fluid density (998 kg·m⁻³), representing neutral buoyancy.

To represent the effect of shape on the force balance required for live fish trajectory calculation, a nonspherical drag model was used in conjunction with the Lagrangian particle representation described above for all live fish strike conditions.

The streamline coordinates and Lagrangian trajectory originating from the particle release location were calculated from the converged flow field.

To perform the DEM simulation, the converged flow field was frozen and an implicit unsteady simulation of the DEM particle release was performed. A Hertz-Mindlin contact model was used to model the interaction of the DEM particle with the blade wall. The DEM particle trajectory was computed from this unsteady simulation.

### Determination of a Strike Intensity Metric (HIT)

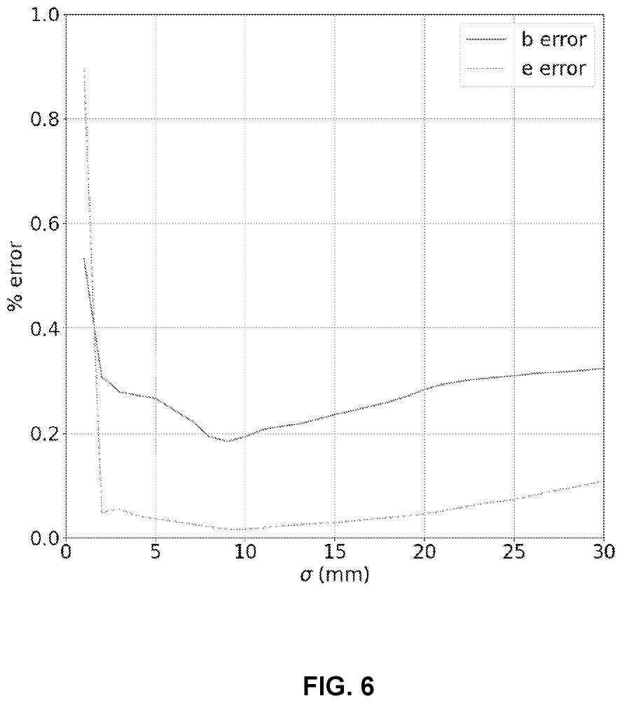

Unlike prior work relating fish survival to velocity at the moment of strike, a metric that takes into account the change in velocity over the course of the strike is proposed in the current disclosure. The moment of strike was identified for DEM particles as the first moment when the particle contacted the blade boundary; for Lagrangian particles and streamlines it was classified as the location of lowest velocity magnitude along the trajectory. FIGS. 6A-6C show the components of velocity plotted against trajectory path length for streamlines, and Lagrangian, and DEM particles, respectively.

Because the trajectory data from CFD was discrete, the velocity data was linearly interpolated and sampled for pre-and post-strike values at a distance o before and after the moment of strike, for all conditions, which represents the distance traveled by the fish before and after the moment of strike.

A strike intensity metric (HIT metric) was calculated as the magnitude of the components of the change in velocity, with units of ms⁻¹ (Equation 2).

$$HIT = \sqrt{{( {v}_{x , pre} - {v}_{x , post} )}^{2} + {( {v}_{y , pre} - {V}_{y , post} )}^{2} + {( {V}_{z , pre} - {V}_{z , post} )}^{2}} \qquad ( 2 )$$

### Results

Results from Different Particle Tracking Approaches

Streamlines, Lagrangian particle trajectories, and DEM particle trajectories were calculated for the simulation on the medium grid across all 45 strike conditions, and summarized in Tables 3 and 4.

TABLE 3
Simulation strike velocity magnitude for streamline, Lagrangian, and DEM trajectories,
determined from moment of minimum velocity; components of velocity pre-and post-
strike for DEM used to calculate the HIT metric; and computed HIT value, for the
strike conditions from the first study conducted in 2006 and 2007.

| | Str | Lgrg | DEM | | | |
|---|---|---|---|---|---|---|
| | ν_{mag} | ν_{mag} | \vec{νₚᵣₑ} | ν_{mag} | \vec{νₚₒₛₜ} | HIT |
| A | 2.17 | 2.15 | (2.62, 0.09, 0.03) | 0.66 | (0.24, 0.85, 0.15) | 2.50 |
| B | 3.92 | 3.79 | (4.22, 0.22, 0.05) | 1.28 | (0.92, 1.77, 0.25) | 3.65 |
| C | 5.80 | 5.62 | (6.14, 0.34, 0.06) | 2.12 | (1.74, 0.85, 0.38) | 4.99 |
| D | 2.64 | 2.60 | (2.81, 0.05, 0.02) | 1.41 | (0.36, 1.77, 0.22) | 2.53 |
| E | 4.42 | 4.39 | (4.57, 0.11, 0.04) | 2.19 | (0.90, 2.69, 0.51) | 3.97 |
| F | 3.94 | 4.44 | (6.50, −0.04, 0.05) | 0.70 | (0.19, 0.66, 0.07) | 6.40 |
| G | 3.03 | 3.02 | (3.04, 0.04, 0.02) | 2.25 | (2.85, 1.55, 0.05) | 1.99 |
| H | 4.78 | 4.79 | (4.91, 0.03, 0.03) | 0.60 | (0.34, −1.07, 0.37) | 4.51 |
| I | 5.12 | 5.33 | (7.06, −0.01, 0.04) | 3.26 | (0.19, 1.21, 0.28) | 6.99 |
| J | 6.12 | 6.11 | (6.03, 0.90, 0.04) | 3.37 | (2.85, 3.99, 0.34) | 4.44 |
| K | 3.01 | 2.84 | (5.50, −0.04, 0.07) | 1.63 | (0.34, −1.72, −0.09) | 5.43 |
| L | 6.31 | 6.33 | (6.42, −0.88, 0.06) | 5.80 | (2.19, −4.17, −0.37) | 5.38 |
| M | 0.64 | 1.39 | (4.50, −0.03, 0.07) | 1.20 | (0.18, −1.36, −0.03) | 4.52 |
| N | 5.98 | 6.05 | (5.96, −3.25, 0.07) | 6.60 | (4.66, −5.03, −0.05) | 2.22 |
| O | 3.01 | 3.52 | (5.25, −0.52, 0.07) | 1.03 | (0.65, −2.67, −0.15) | 5.08 |
| P | 4.09 | 4.42 | (5.91, −0.41, 0.07) | 1.96 | (0.73, −2.31, −0.24) | 5.52 |
| Q | 4.88 | 5.44 | (6.33, −0.87, 0.07) | 1.92 | (1.08, −4.14, −0.29) | 6.19 |
| R | 1.80 | 2.67 | (5.02, −0.13, 0.08) | 1.74 | (0.29, −1.73, −0.13) | 5.10 |
| S | 2.86 | 3.29 | (5.38, −0.42, 0.16) | 0.94 | (0.24, −1.87, −0.10) | 4.76 |
| T | 4.88 | 5.43 | (5.74, −0.88, 0.07) | 2.67 | (1.15, −4.14, −0.24) | 6.13 |
| U | 4.29 | 4.57 | (7.08, −0.83, 0.06) | 1.95 | (1.48, −3.62, −0.12) | 4.51 |
| V | 1.79 | 1.99 | (9.90, 0.17, 0.17) | 2.16 | (0.17, 1.44, 0.23) | 5.36 |
| W | 3.88 | 4.52 | (8.72, −0.88, 0.22) | 2.48 | (0.91, −3.14, −0.05) | 5.35 |
| X | 7.50 | 7.79 | (7.26, −3.06, 0.19) | 6.78 | (2.56, −6.89, −0.32) | 5.95 |

TABLE 4
Simulation strike velocity magnitude for streamline, Lagrangian, and DEM trajectories,
determined from moment of minimum velocity; components of velocity pre-and
post-strike for DEM used to calculate the HIT metric; and computed HIT value,
for the strike conditions from the second study conducted in 2019.

| | Str | Lgrg | DEM | | | |
|---|---|---|---|---|---|---|
| | ν_{mag} | ν_{mag} | \vec{νₚᵣₑ} | ν_{mag} | \vec{νₚₒₛₜ} | HIT |
| a | 8.09 | 8.08 | (9.90, 5.05, 0.25) | 11.39 | (11.04, 3.71, 0.22) | 1.76 |
| b | 8.39 | 8.22 | (8.72, 3.38, 0.13) | 8.53 | (6.23, 5.31, 0.42) | 3.17 |
| c | 5.06 | 5.4 | (7.26, −0.48, 0.10) | 1.63 | (0.77, −2.72, −0.32) | 6.88 |
| d | 6.1 | 6.09 | (5.97, 0.84, −0.62) | 5.64 | (4.48, 1.65, −1.71) | 2.02 |
| e | 5.93 | 5.94 | (6.26, 0.20, −0.25) | 5.16 | (4.15, 0.74, −2.20) | 2.92 |
| f | 7.67 | 7.95 | (8.38, 0.38, −1.01) | 7.84 | (6.25, 0.86, −2.79) | 2.82 |
| g | 7.85 | 8.08 | (8.89, 0.16, −0.24) | 7.88 | (5.82, 0.72, −3.03) | 4.19 |
| h | 8.76 | 9.54 | (10.06, 0.44, −1.31) | 9.43 | (6.93, 1.03, −3.68) | 3.97 |
| i | 7.17 | 8.93 | (10.02, 0.21, −1.39) | 9.33 | (6.75, 0.62, −3.81) | 4.1 |
| j | 0.83 | 7.46 | (10.67, 0.02, −0.35) | 10.19 | (7.85, 0.15, −2.90) | 3.8 |
| k | 8.13 | 8.05 | (8.01, 1.16, −1.18) | 6.55 | (3.8, 2.91, −3.29) | 5.03 |
| l | 8.16 | 7.88 | (8.87, 0.46, −1.83) | 7.43 | (3.66, 1.36, −4.83) | 6.08 |
| m | 5.31 | 5.23 | (5.06, 1.15, −0.88) | 3.57 | (2.17, 3.19, −1.73) | 3.63 |
| n | 5.69 | 5.63 | (5.53, 1.01, −0.66) | 3.42 | (1.99, 2.96, −1.86) | 4.22 |
| o | 7.05 | 6.89 | (6.87, 1.29, −1.32) | 5.06 | (2.38, 3.81, −2.79) | 5.35 |
| p | 7.78 | 7.72 | (7.65, 1.37, −0.99) | 5.11 | (2.45, 4.02, −2.65) | 6.07 |
| q | 6.75 | 6.34 | (8.07, 0.48, −1.69) | 3.81 | (2.29, 1.93, −3.93) | 6.37 |
| r | 8.62 | 8.80 | (8.70, −1.63, −1.29) | 6.89 | (2.95, −3.68, −3.13) | 6.37 |
| s | 8.50 | 8.48 | (8.76, 3.49, −0.12) | 8.91 | (5.90, 5.54, −0.11) | 3.52 |
| t | 5.73 | 5.60 | (5.42, 1.61, −0.04) | 5.13 | (2.25, 4.18, 0.13) | 4.08 |
| u | 5.62 | 5.85 | (6.94, −0.71, −0.05) | 1.61 | (0.90, −2.95, −0.51) | 6.47 |

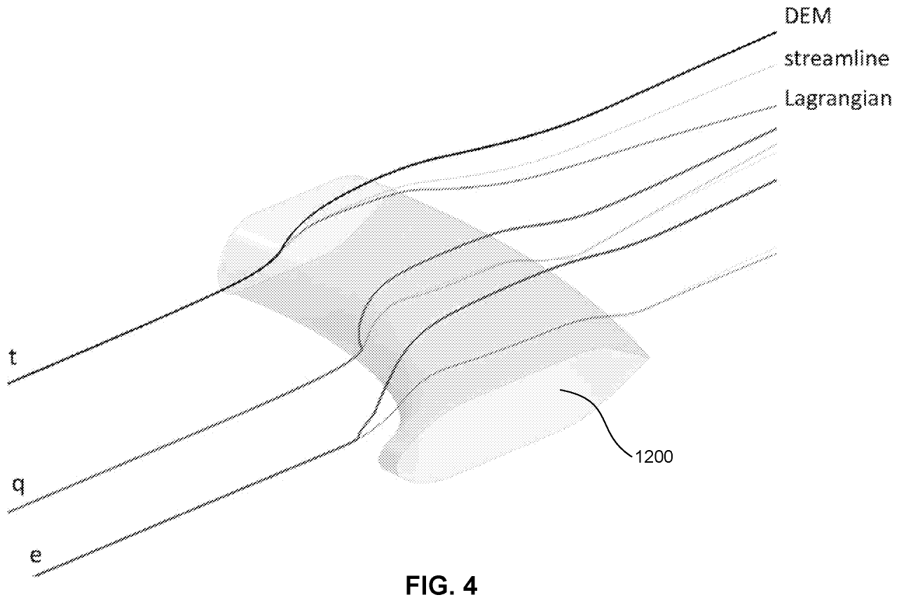

Trajectories for three strike conditions (t, q, e) released from different locations with respect to RHT100 blade, representing DEM particles, Lagrangian particles, and streamlines are illustrated in FIG. 4, where the lightest line represents a streamline, the medium opacity line represents the Lagrangian particle trajectory, and the bold line represents the DEM particle trajectory.

Streamlines and Lagrangian particles produced similar results around the strike event, slowing slightly in advance of the blade and then immediately accelerating around the leading edge after strike to a velocity exceeding their approach velocity. In some cases, the streamline and Lagrangian particles (which are represented as point particles in the simulation) fully evaded the blade. In contrast, DEM particles underwent a reduction in velocity magnitude over the course of the strike, eventually accelerating to a velocity greater than their approach velocity as they passed over the blade.

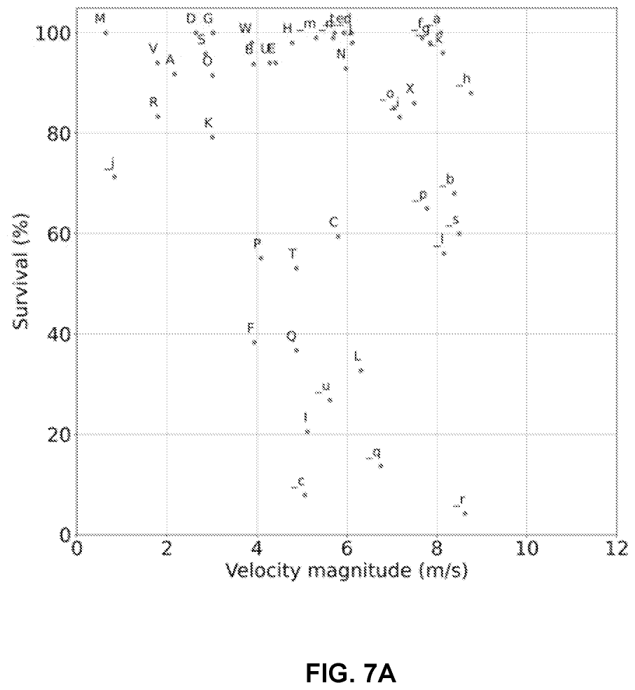

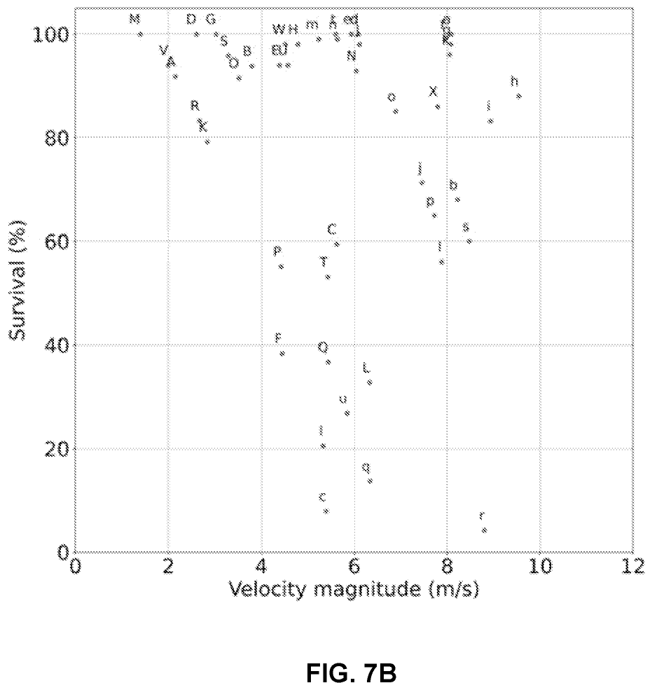

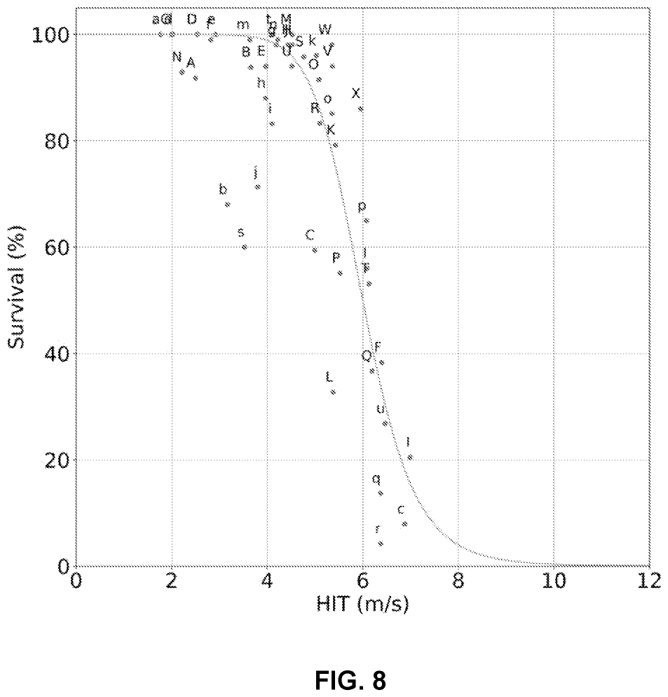

In FIG. 7A, streamline strike velocities are plotted against survival rates across all 45 conditions. In FIG. 7B, Lagrangian particle strike velocities are plotted against survival rates across all 45 conditions. In FIG. 8 the HIT strike metric calculated from Equation 2 is plotted against survival rates for the DEM particles across all 45 conditions. A 2-parameter log-logistic regression was performed on the HIT strike metric vs. survival rates using Equation 3.

$$SURV ( HIT ; b , e ) = \frac{100}{1 + {( \frac{HIT}{e} )}^{b}} \qquad ( 3 )$$

### Selection of Pre-and Post-strike Path Length σ for HIT Metric Calculation

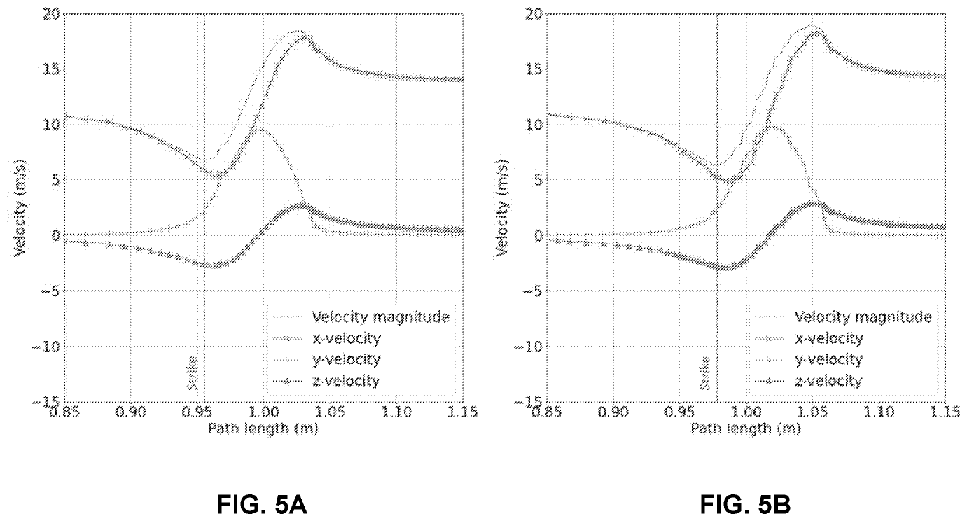

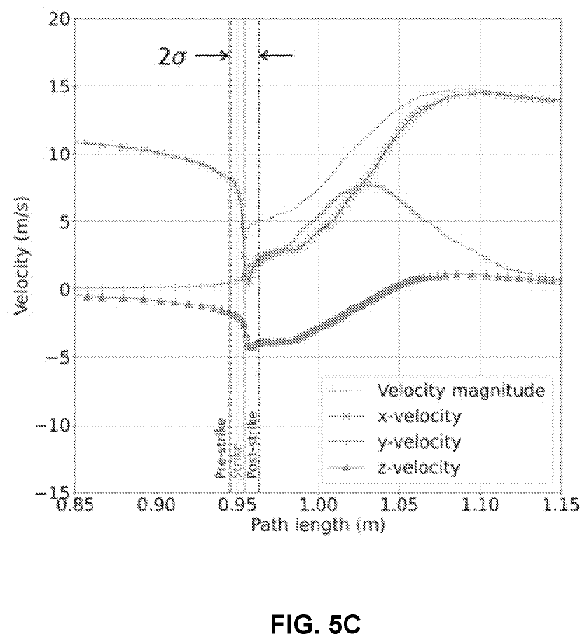

The pre-and post-strike velocities were sampled from DEM trajectory data at a distance σ which captured the effect of particle slowing from the free-stream velocity upon blade approach, as well as the minimum velocity of the particle after contact (FIG. 5C).

Distance σ was varied between 1 and 30 mm to determine which sampling location best correlated the computed HIT value to fish survival across the 45 strike conditions, which is plotted in FIG. 6. The σ value of 9 mm resulted in the lowest error in the log-logistic curve coefficients, and was therefore used for calculation of the HIT values reported in current disclosure. Distance σ can also be described relative to the length of fish, for example distance σ can be in a range of 0.04 times to 0.06 times of the length of the rainbow trout tested.

### Discussion

The streamline and Lagrangian methods were simplest to simulate computationally as they were directly computed from the flow field, and represented the fish as a point object during collision with the blade wall. They also produced nearly identical trajectories in the vicinity of the strike, tending to deviate only near the trailing edge of the blade. In two EPRI10 blade cases (G, H), where the centerline offset was 24.5 and 15.3 mm respectively, the streamline and Lagrangian trajectories entirely missed the blade, but the DEM trajectory registered contact. In some cases, particularly when the streamline approached the blade very close to the stagnation point of the thickest blades (i.e. EPRI100 and EPRI150), it entered the boundary layer and remained inside it across the entire blade. This occurrence was less likely with the Lagrangian particle and not possible for the DEM particles.

Most low-mortality strikes occurring at a small tip slants θ≤45° (f, g, h, i, k, l) correctly registered as low severity with the DEM HIT metric approach, but were not distinguishable from higher severity (lower survival) strikes with the strike velocity derived from streamlines and Lagrangian particle trajectories. Another weakness of the streamline/Lagrangian approach was the tendency for particles to smoothly enter and travel through the boundary layer, registering a lower velocity/severity at strike than expected. Under these conditions, the DEM particle followed a physically feasible trajectory due to the resolving of its spherical surface interaction with the blade, and captured the change in velocity over the strike.

Two strike conditions (b, s) corresponding to the release point farthest offset from blade centerline were poorly modeled by DEM, streamline, and Lagrangian approaches. All trajectory types skirted around the blade for these two conditions, resulting in high velocity magnitudes in the vicinity of the blade for streamline/Lagrangian trajectories, and low changes in velocity for the DEM/HIT approach. This scenario is expected to occur more often at high L/t ratios in which a spherical particle does not represent the “strike-sensitive” region of the fish body (near its center of mass) appropriately.

All three CFD-based trajectory approaches produce a more useful result than survival models which consider relative velocity (and L/t ratio) alone because they capture the local flow effects acting on the fish prior to blade contact that can act to reduce the effective strike velocity.

However, neither the streamline nor Lagrangian strike velocity magnitude data produced useful trends when paired with corresponding survival data across the variety of strike conditions tested. In contrast, the HIT strike severity metric from DEM trajectory data showed a clear drop-off in survival around 6 m/s and was well-suited to a log-logistic dose response curve fit.

### Conclusions

In current disclosure, survival data from 45 unique laboratory strike test conditions were compared to strike velocity magnitude and a novel strike intensity (HIT) metric derived from CFD simulations of each condition. In each CFD simulation, the blade velocity and shape, and fish size and position relative to the blade replicated the experimental conditions performed with live rainbow trout. Current disclosure is distinct from other approaches that focus on fish physiology and the variety of ways that fish of different species and life stages may become injured by turbine blades, in that it focuses on the flow field and its propensity to transport fish away from the direct path of the blade, and directly relates simulation outputs to known survival outcomes. It is expected that these fluid dynamic effects are relevant for all fish that enter turbines, and this approach is particularly relevant for assessing hydropower technologies that employ design features to make them safer for fish (thicker, slanted blades, and low or moderate blade speeds).

Streamlines, which represent a particle passively advected by the flow, and Lagrangian particles, for which trajectories are calculated based on a force balance on a sphere of specified diameter, produced similar results up to and in the vicinity of the strike. Unlike these approaches, which represent the particle as a single point in contact with the blade, the DEM particle approach treats the particle as a sphere with modeled surface contact interaction with the blade wall during strike. DEM particles took distinct trajectories from the streamline and Lagrangian particles, and also revealed a sharp change in components of velocity over the course of the strike. This change in velocity and its robust correlation to strike survival across the range of conditions tested formed the basis of the HIT metric.

The dose-response relationship represented by the log-logistic regression between DEM-based strike severity HIT metric and average survival across the 45 test conditions may be used to assess strike survival rate for a population of fish of various sizes passing through the simulation of a complete turbine. This CFD-based approach to blade strike modeling could inform turbine design for fish safety at the design stage, evaluated in tandem with the typical coefficients of flow, head, power, and efficiency within the same CFD simulation.

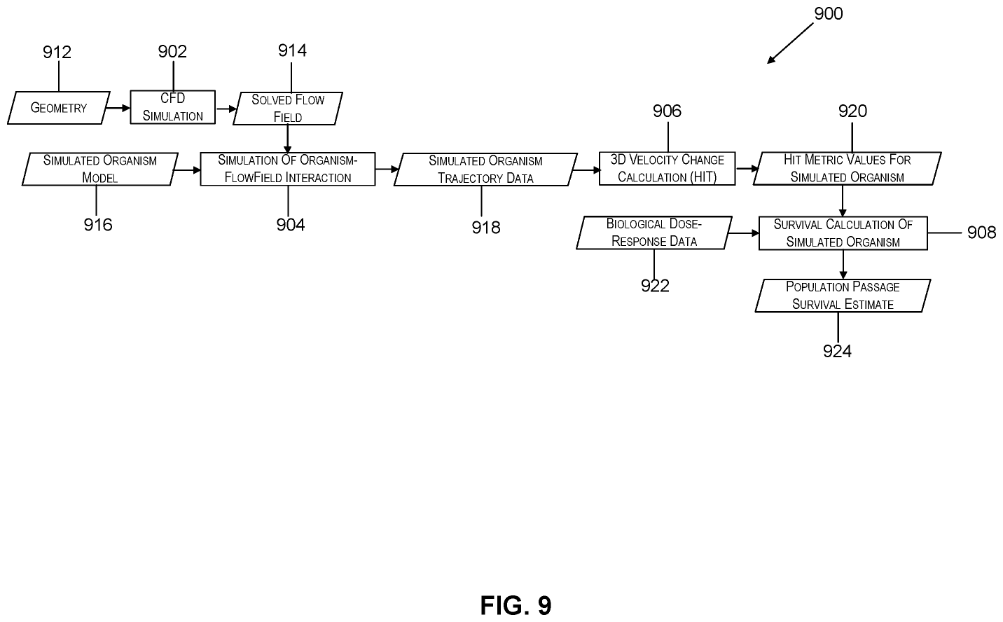

FIG. 9 illustrates a method 900 of estimating survival rate of an organism striking a surface of an object. In some aspects, at a step 902, a CFD simulation is created from geometry 912 of the object, and a solved flowfield 914 is calculated. In some aspects, at a step 904, a simulated organism model 916 is interacted with solved flowfield 914 to simulate the interaction between the organism and the object, and simulated organism trajectory data 918 is produced. In some aspects, at a step 906, trajectory data 918 is used to calculate the HIT metric values 920 for simulated organism 916. In some aspects, HIT metric 920 represents the three-dimensional change in velocity experienced by the simulated organism 904 as it moves through flowfield 914. Finally, in some aspects, at a step 908, relevant biological dose-response data 922, such as the data from live fish strike testing, is correlated with HIT metric 920 to calculate the survival rate of simulated organism 916. In some aspects, a regression analysis is performed to fit biological dose-response data 922 with HIT metric 920. In some aspects, a log-logistic regression analysis is performed to fit biological dose-response data 922 with HIT metric 920. In some aspects, numerous simulated organisms 916 can be released into the flowfield 914, enabling an estimate of the population survival to be calculated.

The simulated organism-flowfield interaction at step 904 is driven by a set of kinematic equations and force balance that determine an organism's position in the flow-field. In the dataset described in detail in current disclosure, the organism-flowfield interaction model treated the fish as a passive particle whose motion was entirely the result of forces from the flowfield and from any wall contact. However, it is also possible to include additional body-forces acting on the simulated organism, such as forces to model organism volition (i.e. fish behavior in response to its surroundings).

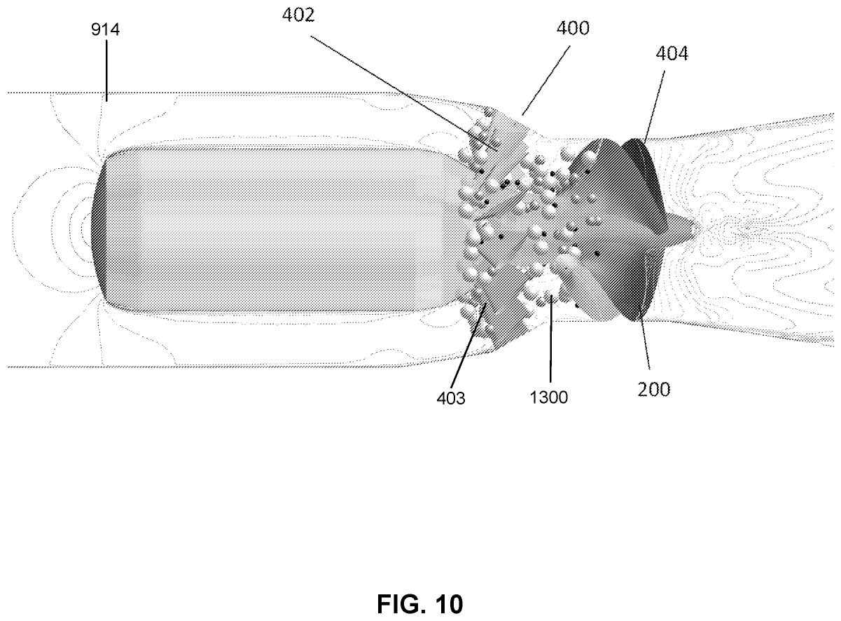

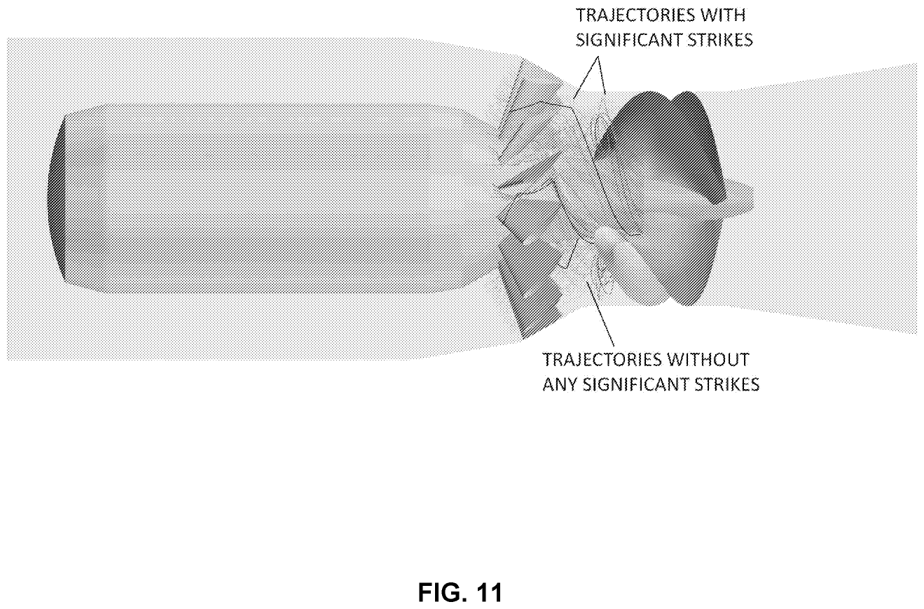

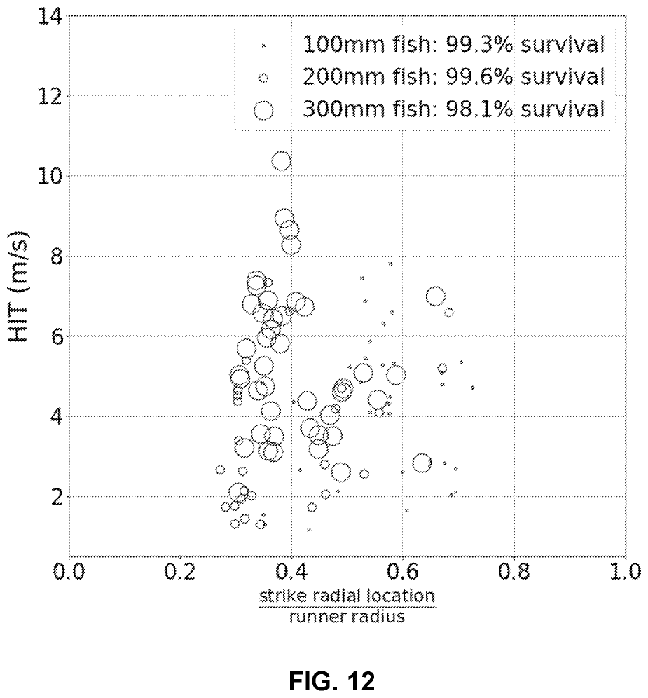

In some aspects, one application of the modeling method of current disclosure is to estimate population strike survival rate for organisms being passed downstream through a turbine. FIG. 10 illustrates a CFD model of a hydropower turbine 400 having radial-inflow wicket gates 402 and a runner 404 with two blades 200. In some aspects, a thickness of blade 200 is in a range of 10 mm to 250 mm. Numerous simulated fish modeled as DEM particles 1300 with properties representative of fish of three different lengths (100 mm, 200 mm, and 300 mm) are released into flowfield 914 at an injection location 403 upstream of wicket gates 402. FIG. 11 illustrates a subset of the simulated fish trajectories which are characterized by high HIT values. FIG. 12 illustrates the distribution of strikes versus the strike radial location normalized by the runner diameter, as well as the resulting population survival estimates for each size of fish for the geometry of turbine 400 in FIG. 10, at its particular operating condition. These outputs can then be further utilized to generate additional plots characterizing the estimated fish survival rates at a wide range of turbine operating conditions.

In some aspects, the modeling method of current disclosure can be used to estimate population passage survival rate for organisms contacting arbitrary wall geometries, not only a turbine blade. For example, the method can also be used for predictions of survival rate from striking other surfaces, such as stayvanes, wicket gates, piers, or any other wall.

In some aspects, the modeling method of current disclosure can be used with any appropriate set of biological dose-response data, not just the dataset disclosed herein. For example, a different species, such as sturgeon, which has a very different body type compared to the rainbow trout used in the dataset disclosed herein, will potentially have a differently-shaped dose-response regression curve, but the overall method should be applicable regardless of the body shape. In some aspects, the modeling method can be used to model fish having a length in a range of 60 mm to 600 mm. In some aspects, the modeling method can also be used for other organisms besides fish, such as frogs, crayfish, or eggs.

In some aspects, the simulated organism model can be extended beyond what is mentioned in detail in this disclosure (i.e. streamlines, Lagrangian particles, and spherical DEM particles), to include the use of clusters of particles or nonspherical particles, which might be used to better resolve and thus model the strike behaviors of certain organisms. Good examples of fish that would benefit from this modeling approach are eel or lamprey, which have very elongated bodies, where a cluster of DEM particles would properly allow prediction of fish-wall contact in a way that a single-point particle would not.

It is to be appreciated that the Detailed Description section, and not the Summary and Abstract sections, is intended to be used to interpret the claims. The Summary and Abstract sections may set forth one or more but not all exemplary aspects of the present disclosure as contemplated by the inventor(s), and thus, are not intended to limit the present disclosure and the appended claims in any way.

The foregoing description of the specific aspects will so fully reveal the general nature of the disclosure that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

What is claimed is:

1. A method of modeling strike survival rate of an organism, the method comprising:
striking an organism with an object under different strike conditions;
recording a strike survival rate of the organism under each of the strike conditions;
performing a regression analysis on the recorded strike survival rates to result in a relationship between strike survival rate and strike intensity metric;
simulating the organism, the object, and the strike conditions in a computational fluid dynamic model;
calculating a strike intensity metric experienced by the simulated organism under each of the simulated strike conditions; and
estimating strike survival rates of the simulated organism under the simulated strike conditions based on the relationship between strike survival rate and strike intensity metric.

2. The method of claim 1, wherein the strike conditions comprise:
a strike velocity;
a geometry of the object; and
a geometry of the organism.

3. The method of claim 2, wherein the organism is fish, and wherein the geometry of the organism comprises a length of the fish.

4. The method of claim 3, wherein the length of fish is in a range of 100 mm to 600 mm.

5. The method of claim 2, wherein the object is a hydropower turbine blade, and wherein the geometry of the object comprises a thickness of the blade and a leading edge slant angle of the blade.

6. The method of claim 5, wherein the leading edge slant angle is in a range of 30 degrees to 90 degrees.

7. The method of claim 6, wherein the thickness of the blade is in a range of 10 mm to 250 mm.

8. The method of claim 2, wherein the strike velocity is in a range of 3.0 m/s to 25 m/s.

9. The method of claim 1, wherein the calculating strike intensity metric comprises:
determining the moment of strike, where the simulated organism contacts the simulated object;
determining components of a pre-strike velocity of the simulated organism at a first distance before the moment of strike;
determining components of a post-strike velocity of the simulated organism at a second distance after the moment of strike; and
calculating the strike intensity metric as the magnitude of components of a change in the pre-strike velocity and the post-strike velocity.

10. The method of claim 9, wherein the first distance and the second distance are equal.

11. The method of claim 9, wherein the organism is a rainbow trout having a length, and wherein the first distance and the second distance are both in a range of 0.04 times to 0.06 times of the length of the rainbow trout.

12. The method of claim 1, wherein the step of simulating comprises simulating the organism as spherical discrete element method (DEM) particles.

13. The method of claim 1, wherein the step of simulating comprises simulating the organism as non-spherical discrete element method (DEM) particles.

14. The method of claim 1, wherein the step of simulating comprises simulating the organism as clusters of discrete element method (DEM) particles.

15. The method of claim 1, wherein the regression analysis is a log-logistic regression analysis.
